(19) United States
(12) Patent Application Publication
(10) Pub. No.: US 2011/0210101 A1
(43) Pub. Date: Sep. 1, 2011

(54) PROCESSES FOR USING A PLASMA ARC TORCH TO OPERATE UPON AN INSULATION-COATED WORKPIECE

(75) Inventors: Robert L. Smallwood, Florence, SC (US); Joseph V. Warren, JR., Florence, SC (US)

(73) Assignee: The ESAB Group, Inc.

(21) Appl. No.: 12/715,078

(22) Filed: Mar. 1, 2010

(51) Int. Cl. B23K 9/00

(52) U.S. Cl. 219/121.44; 219/121.59

(57) ABSTRACT

A process for using a plasma arc torch is provided that includes operating a power source of the plasma arc torch to initiate an electric arc between an electrode of the plasma arc torch and a nozzle of the plasma arc torch at a starting arc current. A flow of argon-containing gas can be provided through the nozzle while the arc exists between the electrode and the nozzle, and the power source operated to cause the arc to extend out from the nozzle to a coating of insulation on a workpiece. The arc may ionize at least part of the argon-containing gas so as to burn through the insulation of the workpiece and attach the arc to metal of the workpiece. Thereafter, the flow of argon-containing gas can be halted and a flow of a different gas can be provided while increasing the arc current above the starting arc current.

### BACKGROUND

The present invention relates to plasma arc torch machines, and more particularly to processes of using plasma arc torch machines for cutting protective-coated workpieces.

Plasma arc devices are commonly used for cutting and welding. One conventional plasma arc torch includes an electrode positioned within a nozzle. A pressurized gas is supplied to the torch and flows between the electrode and the nozzle, and an arc is established between the electrode and a workpiece. The arc ionizes the gas, and the resulting high temperature gas and associated electrical current can be used for cutting or welding operations.

One typical method for starting the torch is to first initiate a pilot mode by establishing an arc at a low current between the electrode and the nozzle. The torch is then switched from the pilot mode to a transfer or working mode by transferring the arc to the workpiece so that the arc extends between the electrode and the workpiece, and increasing the current of the arc. A non-oxidizing gas can be supplied to the torch during the pilot mode to reduce the oxidation and erosion of the electrode, and an oxidizing gas can be supplied thereafter during operation.

When a workpiece has a bare metal surface, it is relatively easy to get the pilot arc to attach to the workpiece. However, when a workpiece has an insulating coating layer, such as TEFLON®, vinyl, plastic, or the like, it is relatively difficult to get the pilot arc to attach to the workpiece. Such coatings are sometimes provided on workpieces in order to protect the surface finish, as when the workpiece will be used as a decorative part. Protective coatings on a workpiece may be various shapes and sizes. Typically, a coating on a workpiece may be substantially uniform with a constant thickness on the order of 0.1-0.25 mm. A coating may have an adhesive backing, such as tape, glue, or other tacky substance, which allows the coating to at least partially attach to a workpiece.

### SUMMARY

The applicants have discovered that with conventional methods, the pilot arc will not transfer to a workpiece that has an insulating or protective coating portion between the nozzle and workpiece. As soon as the HF power source or capacitive discharge is turned off, the pilot arc extinguishes. The problem with this situation is that the HF current and capacitive discharge are detrimental to the plasma arc torch machine including the torch nozzle (e.g., rapid nozzle wear), such that it is desired to operate the HF power source or capacitive discharge only for very short time periods. Thus, the problem cannot be solved satisfactorily by merely leaving the HF power source on or capacitive discharge active, as this would lead to very short nozzle lifetimes as well as machine damage.

In the past, in some plasma arc torch systems a scribe was provided on the torch head. The scribe was used to “prick” or pierce through any insulating coating on a workpiece in order to expose bare metal to which the pilot arc would easily attach. This is not a desirable solution, however, because it is time-consuming and complicates the torch mechanism. Accordingly, there is a need for improved methods for using plasma arc torches to operate upon insulation/protective-coated workpieces.

In one aspect, a process for using a plasma arc torch is provided. The process includes operating a power source of the plasma arc torch to initiate an electric arc between an electrode of the plasma arc torch and a nozzle of the plasma arc torch at a starting arc current, which starting arc current may be less than 70 amperes (A), less than 50 A, and/or about 20 A. A flow of argon-containing gas (such as, for example, pure argon) can be provided through the nozzle while the arc exists between the electrode and the nozzle.

The power source of the plasma arc torch can be operated to cause the arc to extend out from the nozzle to a coating of insulation (e.g., vinyl, fluoropolymer, and/or plastic with a thickness of about 0.1-0.25 mm) on a workpiece. For example, the power source of the plasma arc torch can be operated so as to cause a capacitive discharge, and the power source of the plasma arc torch can then be operated so as to terminate the capacitive discharge once the arc is extended out to the coating of insulation on the workpiece. Alternatively, or additionally, the power source of the plasma arc torch may be operated so as to generate a low frequency of current modulation.

The arc may ionize at least part of the argon-containing gas so as to burn through the insulation of the workpiece and attach the arc to metal of the workpiece. Once the arc has attached to the metal of the workpiece, the flow of argon-containing gas can be halted and a flow of a different gas (e.g., nitrogen and/or oxygen) can be provided while increasing the arc current above the starting arc current. The workpiece can then be cut using the arc.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic side view of a plasma arc torch machine configured in accordance with an example embodiment;

FIGS. 2-8 are schematic side views of the plasma arc torch machine of FIG. 1, which views represent an example process for using the plasma arc torch machine to operate on an insulation coated workpiece; and

FIGS. 9-11 are schematic side views of a plasma rc torch machine configured in accordance with another example embodiment, these views representing another example process for using the plasma arc torch machine to operate on an insulation coated workpiece.

### DETAILED DESCRIPTION

The embodiments will now be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Generally, below are described example processes by which a plasma arc torch machine may be used to operate on an insulation-coated workpiece. The process includes flowing argon gas between the plasma arc torch machine and the workpiece and operating the power source of the machine to cause an electrical arc to extend out from a nozzle of the machine to the coating of insulation on the workpiece. The arc ionizes the argon gas so as to burn through the insulation of the workpiece and thereby allows attachment of the arc to a portion of the workpiece underlying the insulation. Accordingly, the use a HF power source or capacitive discharge may be unnecessary or reduced to a very short period of time.

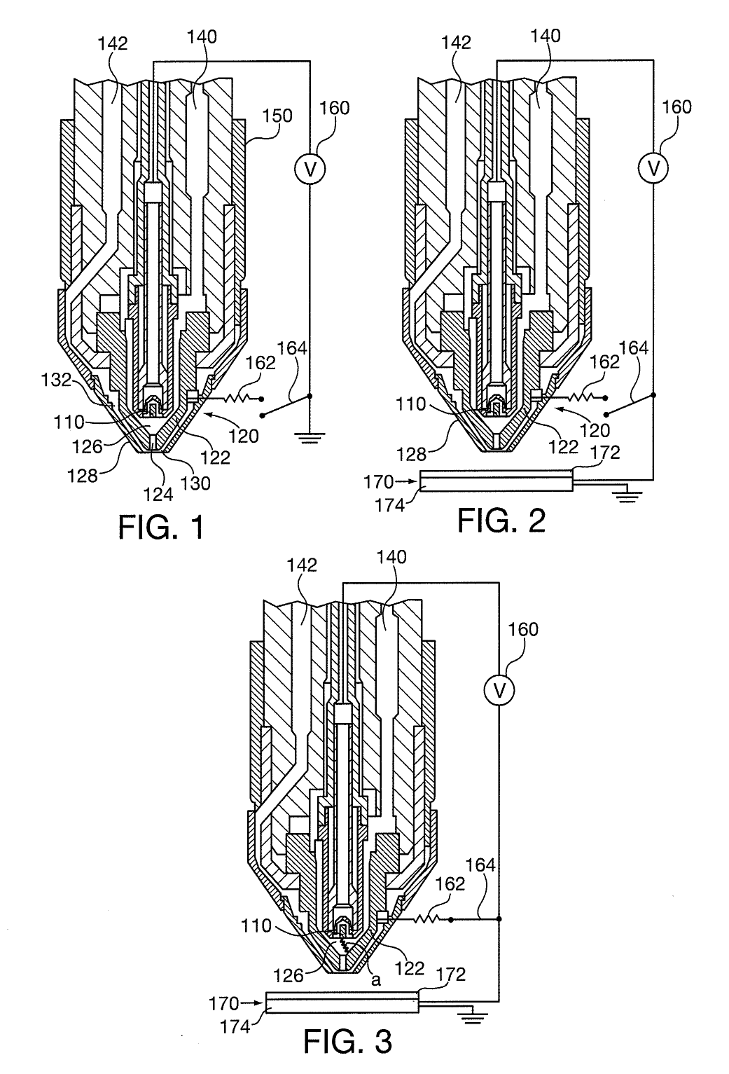

Referring now to FIG. 1, there is shown a plasma arc torch machine 100 configured in accordance with an example embodiment. Although the embodiment of the plasma arc torch machine 100 depicted in FIG. 1 and described below represents one configuration, the machine 100 and the associated method of using the machine 100 may have other configurations. In FIG. 1, the plasma arc torch machine 100 includes a cylindrical or tubular electrode 110 disposed within a nozzle assembly 120. The electrode 110 may be made of, for example, hafnium, tungsten, copper or a copper alloy. In some embodiments, a tube (not shown) can be suspended within a central bore of the electrode 110 for circulating a liquid medium, such as water, through the electrode structure as a coolant, which liquid medium could then be removed via a drain hose (not shown).

The nozzle assembly 120 can include a plasma gas nozzle 122 that at least partially encloses the electrode 110 and includes a plasma gas nozzle orifice 124. For example, the plasma gas nozzle 122 may be an annular structure with an inner diameter that is larger than the outer diameter of the electrode 110, such that a plasma gas chamber 126 is defined by the electrode and plasma gas nozzle. The plasma gas nozzle 122 may be composed at least of metal.

The nozzle assembly 120 may also include a shielding gas nozzle 128 that is disposed radially exterior to the plasma gas nozzle 122. For example, the shielding gas nozzle 128 may be generally annular, and may have a similar shape to that for the plasma gas nozzle 122. The shielding gas nozzle 128 may define a shielding gas nozzle orifice 130, which may be aligned with the plasma gas nozzle orifice 124. The shielding gas nozzle 128 may be configured to have an inner diameter that is larger than the outer diameter of the plasma gas nozzle 122, such that a shielding gas chamber 132 is defined by the shielding gas nozzle and the plasma gas nozzle. The shielding gas nozzle 128 may be composed at least partially of metal and/or a ceramic material, such as alumina. The shielding gas nozzle 128 can be separated from the plasma gas nozzle 122, for example, by a spacer element (not shown), which can be formed of plastic.

The plasma arc torch machine 100 may include a plasma gas inlet tube 140 and a shielding gas inlet tube 142, which connect to the plasma gas chamber 126 and the shielding gas chamber 132, respectively. A source (not shown) of pressurized plasma gas, such as, for example, commercial gas containers filled with nitrogen, oxygen, air, and/or argon-containing gas (such as pure or nominally pure argon), may be connected to the plasma gas inlet tube 140. Similarly, a source (not shown) of pressurized shielding gas, such as, for example, argon, may be connected to the shielding gas inlet tube 142. Either or both of the plasma gas inlet tube 140 and the shielding gas inlet tube 142 may be configured to receive gases from multiple sources, for example, via connection to a gas controller (not shown) that selectively controls the respective flows of gases from various sources into the inlet tubes. For example, the gas controller can include one or more manually adjustable valves that are accessible to the operator, or the controller can be an automated device, such as an automated valve controlled by an electronic control circuit. The plasma gas inlet tube 140 and the shielding gas inlet tube 142 may be incorporated into a plasma torch body 150, along with the electrode 110 and nozzle assembly 120.

The electrode 110 and the plasma gas nozzle 122 may be connected to a voltage source 160, for example, the anode side, that allows, when the voltage source is operated, the electrode and plasma gas nozzle to be electrically biased relative to one another. The voltage source 160 may connect to the plasma gas nozzle 122 through a resistive load 162 via a switch 164. Biasing the electrode 110 and the plasma gas nozzle 122 may allow for establishing an arc of electric current between the two, as discussed further below. In some embodiments, part or all of the voltage source 160, the resistive load 162, and the switch 164 may be incorporated into the plasma torch body 150.

A plasma arc torch machine configured in accordance with an example embodiment, for example, the plasma arc torch machine 100 described above and illustrated in FIG. 1, may be used to perform a plasma arc cutting operation on a workpiece having an insulating coating. An example of such a process is described below, making reference to FIGS. 2-8.

The cutting process begins with the introduction of a workpiece 170 to be cut. The workpiece 170 includes an insulating coating 172 that covers a conductive portion 174, which may be, for example, a metal portion. The workpiece 170 may be positioned such that there is a direct line of sight from the electrode 110 through the nozzle assembly 120 to the coating 172 (see FIG. 2). Further, the workpiece 170 may be connected to the voltage source 160 (e.g., the anode side), such that the workpiece is biased relative to the electrode 110.

Once the workpiece 170 has been appropriately positioned and connected to the voltage source 160, with the voltage source operating in a direct current mode, the switch 164 can be closed in order to establish a difference in electrical potential between the electrode 110 and the plasma gas nozzle 122 (see FIG. 3). This can lead to the formation of an electric arc a across the plasma gas chamber 126 as electrons are emitted from the electrode and collected by the plasma gas nozzle. When the arc a has been established between the electrode 110 and the plasma gas nozzle 122, the plasma arc torch machine 100 is said to be operating in “pilot mode.” The arc current during pilot mode operation (the “pilot arc current”) may be less than 50 A (e.g., 20 A), and should generally provide enough amperage to initiate an electric arc between the electrode 110 and the nozzle 122.

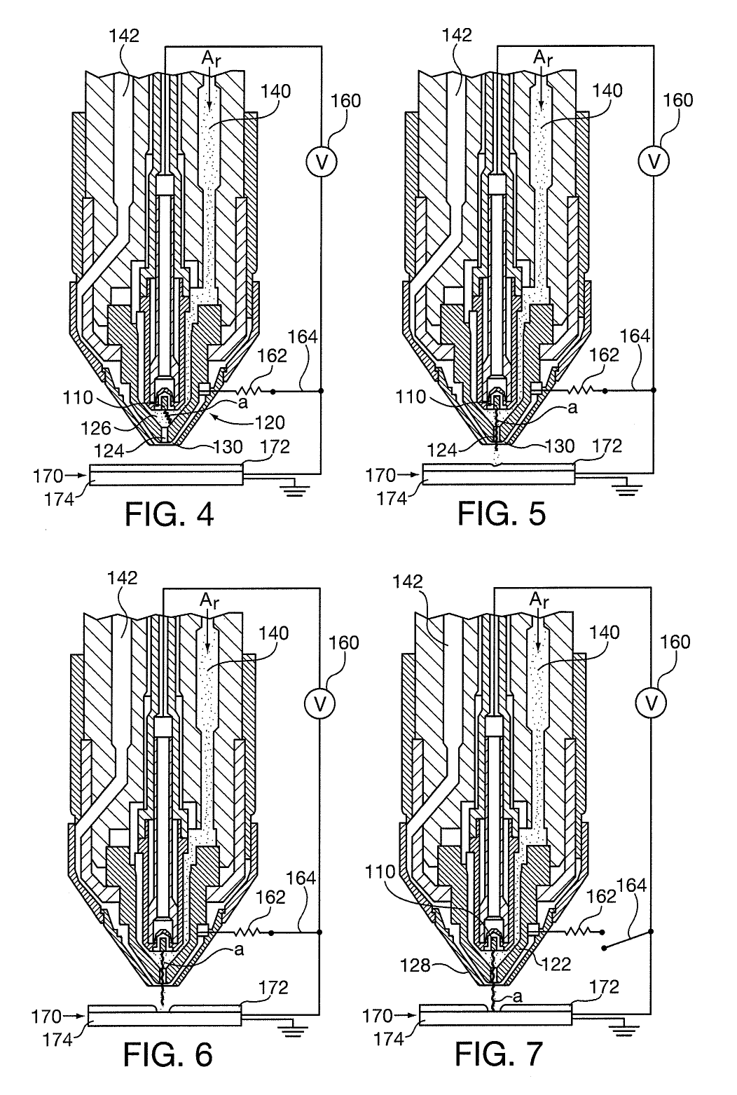

The plasma arc torch machine 100 can then be switched from pilot mode to “working mode,” in which the plasma arc torch machine is configured for operations such as cutting and/or welding. In order to switch to working mode, argon-containing gas can be flowed through the plasma gas inlet tube 140 and into the plasma gas chamber 126 (see FIG. 4). At least part of the argon gas may be ionized by the arc a as the gas passes through the chamber 126, thereby forming an argon plasma. In some embodiments, the argon-containing gas may comprise pure argon. In additional embodiments the argon-containing gas may be nominally pure and contain traces of other gases, while in other embodiments the argon may be mixed with more than trace amounts of other gases, such as nitrogen. The arc a may act to ionize only the argon gas particles, or it may serve to ionize any particles within an appropriate area around the arc. In some embodiments, trace amounts of gases other than argon are maintained at a level below approximately 0.05% of the entire gaseous mixture. In an alternate embodiment where the other gases exceed trace amounts, the gas may comprise 90% argon, 8% carbon dioxide, and 2% oxygen.

Due to the further flow of argon gas from the plasma gas inlet tube 140 into the plasma gas chamber 126, the argon plasma moves from the plasma gas chamber 126 out through the orifices 124, 130 and on to the workpiece 170 (see FIG. 5). As the argon plasma contacts the workpiece 170, the argon ions interact with the insulating coating 172 and act to quickly remove the coating and expose the conductive portion 174 of the workpiece (see FIGS. 5-7).

The argon plasma also facilitates the flow of electrons from the electrode 110 to the workpiece 170, and this allows the arc a to move out of the nozzle assembly 120 and to attach to the conductive portion 174 of the workpiece. The presence of the resistive load 162 ensures that the electrical potential difference between the electrode 110 and the nozzle 122 is less than that between the electrode and the workpiece 170, which further facilitates the attachment of the arc a to the workpiece. Once the arc a has attached to the workpiece 170, the current of the arc a may be increased, such that the “working arc” current may be selected according to the torch operation and may be higher than that for the “pilot arc.” For example, the working arc current can be between about 30 and 400 A. The higher working arc current can be supplied, for example, by the voltage source 160, which may be a variable voltage source or a dual voltage control/current control power source.

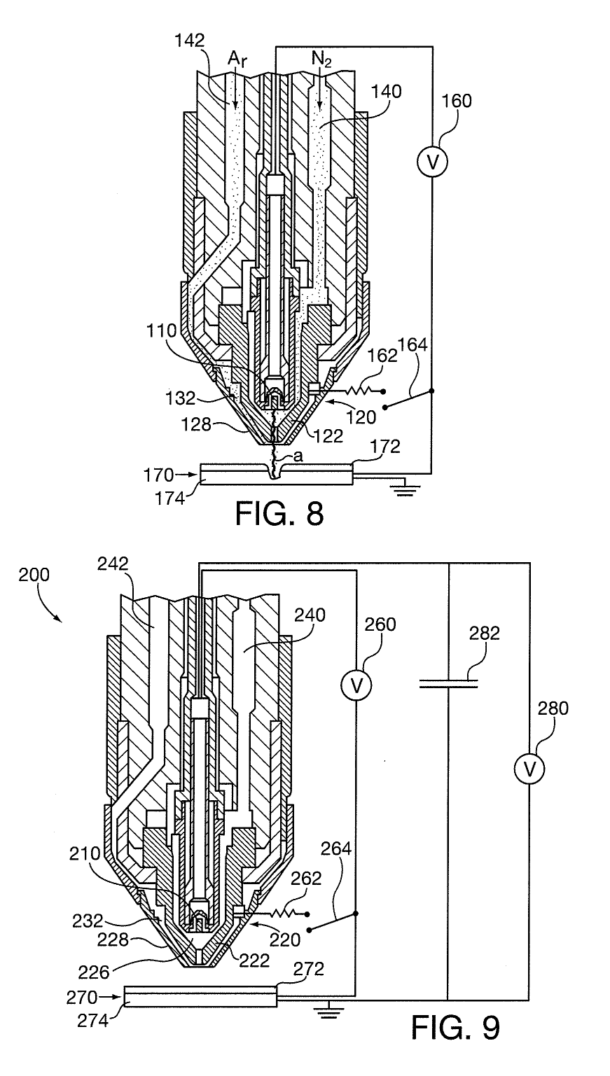

Once the arc a has attached to the workpiece 170, the plasma gas nozzle 122 can be disconnected from the voltage source 160 by opening the switch 164 (see FIG. 7). At that point, the flow of argon gas through the plasma gas inlet tube 140 can be halted, and a different gas can be provided therethrough for facilitating cutting though the workpiece 170 by the arc a. For example, as shown in FIG. 8, nitrogen can be used as the “cutting gas.” Other possible candidates for the cutting gas include, but are not limited to, oxygen and air. Further, argon can be used as the cutting gas to actually remove the material from the cutting path prior to cutting, in which case the flow of argon can be maintained through both the initial and later stages of the process.

A “shielding gas” can also be introduced during the cutting process. The shielding gas can be flowed through the shielding gas inlet tube 142 and into the shielding gas chamber 132, from there exiting the shielding gas nozzle 128 (and the nozzle assembly 120) via the orifice 130. The shielding gas acts to surround the arc with a swirling curtain of gas, thereby isolating the working area from the ambient environment. Examples of possible gases to be used as the shielding gas include, but are not limited to, argon, air, and nitrogen. While the shielding gas is shown as being introduced when the arc a has attached to the workpiece (as in FIG. 8), the shielding gas can be introduced at any point in the process. In some cases, the shielding gas may flow through the shielding gas inlet tube continuously throughout the cutting process.

Referring to FIGS. 9-11, therein is shown a plasma arc torch machine 200 configured in accordance with another example embodiment. In many respects, the plasma arc torch machine 200 shown in FIG. 9 is similar to the plasma arc torch machine 100 shown in FIG. 1 and described above. The plasma arc torch machine 200 includes an electrode 210 disposed within a nozzle assembly 220 including a plasma gas nozzle 222 and a shielding gas nozzle 228. The electrode 210, plasma gas nozzle 222, and shielding gas nozzle 228 may together define a plasma gas chamber 226 and a shielding gas chamber 232 that connect, respectively, to a plasma gas inlet tube 240 and a shielding gas inlet tube 242.

The electrode 210 and the plasma gas nozzle 222 may be connected to a first voltage source 260 that allows, when the voltage source is operated, the electrode and plasma gas nozzle to be electrically biased relative to one another. The first voltage source 260 (say, the anode side) may connect to the plasma gas nozzle 222 through a resistive load 262 via a switch 264. A workpiece 270 may also be connected to the anode side of the first voltage source 260, the workpiece having a conductive portion 274 covered by an insulating coating 272.

Additionally, the electrode 210 and workpiece 270 may be connected to a second voltage source 280, with the workpiece being connected to the anode side of the second voltage source (as it was with the first voltage source 260). A capacitor 282 can be connected in parallel with the second voltage source 280, such that the second voltage source acts to charge the capacitor as a potential difference is established between the electrode 210 and the workpiece 270.

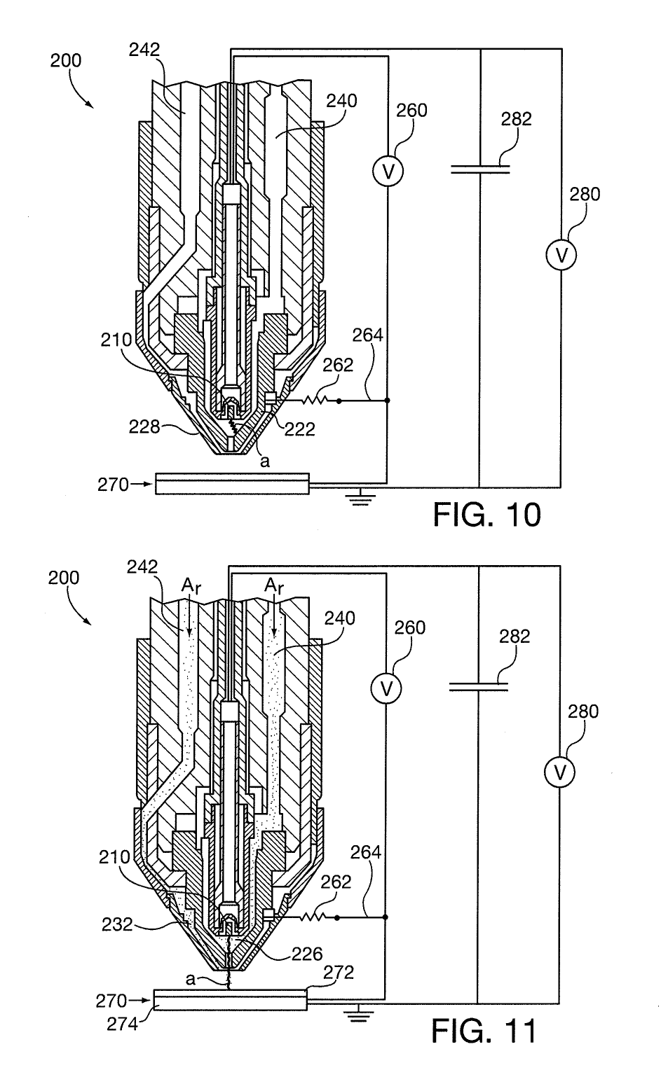

In operation, closing the switch 264 and operating the first voltage source 260 in direct current mode establishes a potential difference between the electrode 210 and the plasma gas nozzle 222, thereby causing an electrical arc α to be established (see FIG. 10). The second voltage source 280 is also operated in a direct current mode, causing the capacitor 282 to charge. Thereafter, a plasma gas, such as argon, can be introduced into the plasma gas chamber 226 via the plasma gas inlet tube 240, and shielding gas, such as air or nitrogen, can be introduced into the shielding gas chamber 232 via the shield gas inlet tube 242. The argon gas is ionized to form plasma, which extends out toward the workpiece 270. The argon plasma creates a conductive path between the electrode 210 and the workpiece 270, allowing the arc a to move to the workpiece. At the same time, a capacitive discharge from the capacitor 282 allows for a significant burst of electrons to be emitted from the electrode 210 to the workpiece 270.

Various details regarding the structure of the above described plasma arc torch machines have been omitted for the sake of brevity. These details are explained more fully in other publications, including U.S. Pat. No. 6,215,090 to Severance et al. (which is commonly assigned with the present application), which is herein incorporated by reference in its entirety.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A process for using a plasma arc torch, the process comprising:
operating a power source of the plasma arc torch to initiate an electric arc between an electrode of the plasma arc torch and a nozzle of the plasma arc torch at a starting arc current;
providing a flow of argon-containing gas through the nozzle while the arc exists between the electrode and the nozzle;
operating the power source of the plasma arc torch to cause the arc to extend out from the nozzle to a coating of insulation on a workpiece, the arc ionizing at least some of the argon-containing gas so as to burn through the insulation of the workpiece and attach the arc to metal of the workpiece; and
once the arc has attached to the metal of the workpiece, halting the flow of argon-containing gas and providing a flow of a different gas while increasing the arc current above the starting arc current.

2. The process of claim 1, further comprising causing a capacitive discharge that facilitates extension of the arc out from the nozzle to the coating of insulation on the workpiece.

3. The process of claim 2, further comprising terminating the capacitive discharge once the arc is extended out to the coating of insulation on the workpiece.

4. The process of claim 1, further comprising cutting the workpiece using the arc.

5. The process of claim 1, wherein said operating a power source of the plasma arc torch to initiate an electric arc between an electrode of the plasma arc torch and a nozzle of the plasma arc torch at a starting arc current includes operating a power source of the plasma arc torch to initiate an electric arc between an electrode of the plasma arc torch and a nozzle of the plasma arc torch at a starting arc current that is less than 70 amperes.

6. The process of claim 1, wherein said operating a power source of the plasma arc torch to initiate an electric arc between an electrode of the plasma arc torch and a nozzle of the plasma arc torch at a starting arc current includes operating a power source of the plasma arc torch to initiate an electric arc between an electrode of the plasma arc torch and a nozzle of the plasma arc torch at a starting arc current that is less than 50 amperes.

7. The process of claim 1, wherein said operating a power source of the plasma arc torch to initiate an electric arc between an electrode of the plasma arc torch and a nozzle of the plasma arc torch at a starting arc current includes operating a power source of the plasma arc torch to initiate an electric arc between an electrode of the plasma arc torch and a nozzle of the plasma arc torch at a starting arc current that is about 20 amperes.

8. The process of claim 1, wherein said operating the power source of the plasma arc torch to cause the arc to extend out from the nozzle to a coating of insulation on a workpiece includes operating the power source of the plasma arc torch to cause the arc to extend out from the nozzle to a coating of insulation on a workpiece, the coating of insulation comprising vinyl.

9. The process of claim 1, wherein said operating the power source of the plasma arc torch to cause the arc to extend out from the nozzle to a coating of insulation on a workpiece includes operating the power source of the plasma arc torch to cause the arc to extend out from the nozzle to a coating of insulation on a workpiece, the coating of insulation comprising fluoropolymer.

10. The process of claim 1, wherein said operating the power source of the plasma arc torch to cause the arc to extend out from the nozzle to a coating of insulation on a workpiece includes operating the power source of the plasma arc torch to cause the arc to extend out from the nozzle to a coating of insulation on a workpiece, the coating of insulation comprising plastic.

11. The process of claim 1, wherein said operating the power source of the plasma arc torch to cause the arc to extend out from the nozzle to a coating of insulation on a workpiece includes operating the power source of the plasma arc torch to cause the arc to extend out from the nozzle to a coating of insulation on a workpiece, the coating of insulation being about 0.1 mm thick.

12. The process of claim 1, wherein said providing a flow of a different gas comprises providing a flow of a gas selected from the group consisting of air and nitrogen.

13. The process of claim 1, wherein said providing a flow of a different gas comprises providing a flow of oxygen.

14. The process of claim 1, wherein said operating the power source of the plasma arc torch to cause the arc to extend out from the nozzle to the coating of insulation on the workpiece comprises operating the power source of the plasma arc torch so as to generate a low frequency of current modulation.
